(19) United States
(12) Patent Application Publication
(10) Pub. No.: US 2019/0120399 A1
(43) Pub. Date: Apr. 25, 2019

(54) ELECTRICAL ACTUATOR WITH HAMMERING MECHANISM

(71) Applicant: Flowinn (Shanghai) Industrial Co., Ltd., Shanghai (CN)

(72) Inventor: KUO-FENG HSU, Shanghai (CN)

(21) Appl. No.: 15/788,817

(22) Filed: Oct. 20, 2017

(51) Int. Cl. F16K 31/04; F16K 31/44

(52) U.S. Cl. CPC F16K 31/043; F16K 31/44

(57) ABSTRACT

An electrical actuator with hammering mechanism includes a driving device, a transmission assembly driven by the driving device, an arc slot formed in the transmission assembly, a hammer element arranged in the arc slot, and a power valve arranged at one side of the hammer element. The driving device, when in operation, drives the transmission assembly to rotate and the arc slot is set in rotation in unison with the transmission assembly, while the hammer element is held at one side of the power valve so that a relative movement is generated between the arc slot and the hammer element. Thus, at the beginning of rotation of the transmission assembly, before the arc slot gets into impact with the hammer element, no loading that results in resistance is present so that full speed rotation can be conducted to thereby increase the kinetic energy before activation of the power valve.

### (a) TECHNICAL FIELD OF THE INVENTION

The present invention generally relates to an electrical actuator with hammering mechanism, and more particularly to an electrical actuator with hammering mechanism that uses, in a limited space, a hammering operation to help smoothly open/close a valve and to prevent inoperability resulting from excessive resistance.

### (b) DESCRIPTION OF THE PRIOR ART

An angular-displacement electrical actuator is provided for achieving automatic operation of equipment and devices mounted on a fluid pipeline and is generally an electrical device used to control a switch valve operable between 0 degree and 90 degrees (namely an angular displacement between 0 degree and 90 degrees). An operation of the angular-displacement electrical actuator is receiving a standard direct-current (DC) signal of a voltage provided from a regulator or other meters, and such a signal is converted, by means of the actuator, into a displacement force or a rotation torque in order to operate a switch or a valve for achieving a mission of automatic regulation.

The torque necessary for opening/closing a valve is determined on the amount of torque output that an electrical actuator (such as a motor) may apply and is generally provided by a user or selected by a valve manufacturer. A manufacturer of actuators is only responsible for the output torque generated by the actuator. The torque that is necessary for a normal operation of opening/closing a valve is determined according to factors including the size of a bore of the valve and operation pressure. However, there are always differences of machining accuracy and assembly operation existing between different manufacturers, valves of the same specification may require different starting or activating torque and this may even true for valves manufactured by the same manufacturers. Thus, valves may often be not normally opened or closed if the actuator used in combination therewith is selected to be one that provides an insufficient torque. Apparently, the selection of the electrical actuator must be made within a reasonable range of torque.

Further, even the selection concerning torque was made correctly, if the valve has been kept in a condition of being not operated for an extended period of time, to re-activate the valve may encounter a condition that the resistance against the operation of opening/closing is unexpectedly increased due to environmental factors or stresses of mechanical components so that the rated torque of the actuator becomes insufficient to open/close the valve. Under this condition, the electrical actuator may suffer over-loading, leading to heating in an excessive manner, malfunctioning, or even breaking down.

### SUMMARY OF THE INVENTION

In view of the above, this invention is made to provide an electrical actuator that involves a hammering mechanism to provide a hammering operation in a limited space to help open/close a power valve so as to eliminate a condition that operation is inhibited by an excessive resistance.

The primary objective of the present invention is to provide a solution for overcoming a condition that a resistance of a device is excessively large and the device becomes inoperable without increasing an output torque of an electrical actuator (driving device) for the purposes of extending an overall service life of the entire equipment.

Another objective of the present invention is to make use of relative sliding between a curved groove and a hammer element to increase an operational speed of an electrical actuator (driving device) for driving operation of a power valve.

To achieve the above objectives, the present invention provides a structure that comprises: a driving device, a transmission assembly arranged at one side of the driving device and driven by the driving device, at least one arc slot formed in the transmission assembly, at least one hammer element arranged in the arc slot. When the transmission assembly is put into operation, the arc slot and the hammer element are caused to move with respect to each other. A power valve is arranged at one side of the hammer element and receives, by means of the hammer element, power supplied from the driving device to operate. A user, with an attempt to operate the present invention, may directly activate the driving device to have the driving device drive the transmission assembly to rotate. The transmission assembly is not directly coupled to the power valve and instead drives the operation by means of the hammer element, and also, the hammer element is only put into operation when pushed by the arc slot, so that the transmission assembly, when rotating, may simultaneously cause the arc slot and the hammer element to generate a relative movement therebetween. Therefore, the driving device may be operated with full speed rotation in a low resistance condition to accumulate a certain amount of kinetic energy before the arc slot impacts the hammer element so as to increase the energy for opening/closing the power valve to help the driving device to drive the power valve that may involve an increased resistance.

With the above technique, the problems of the prior art angular-displacement electrical actuators that activation becomes difficult for being not put into operation for an extended period of time or for loading being excessively large and that over-heating or damages may readily result in case of forced activation can be overcome and an advantage of improving utilization can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing a preferred embodiment of the present invention.

FIG. 2 is a cross-sectional view taken along line A-A of FIG. 1.

FIG. 3 is a schematic view of the preferred embodiment of the present invention.

FIG. 4 is another schematic view of the preferred embodiment of the present invention.

FIG. 5 is a schematic view showing another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

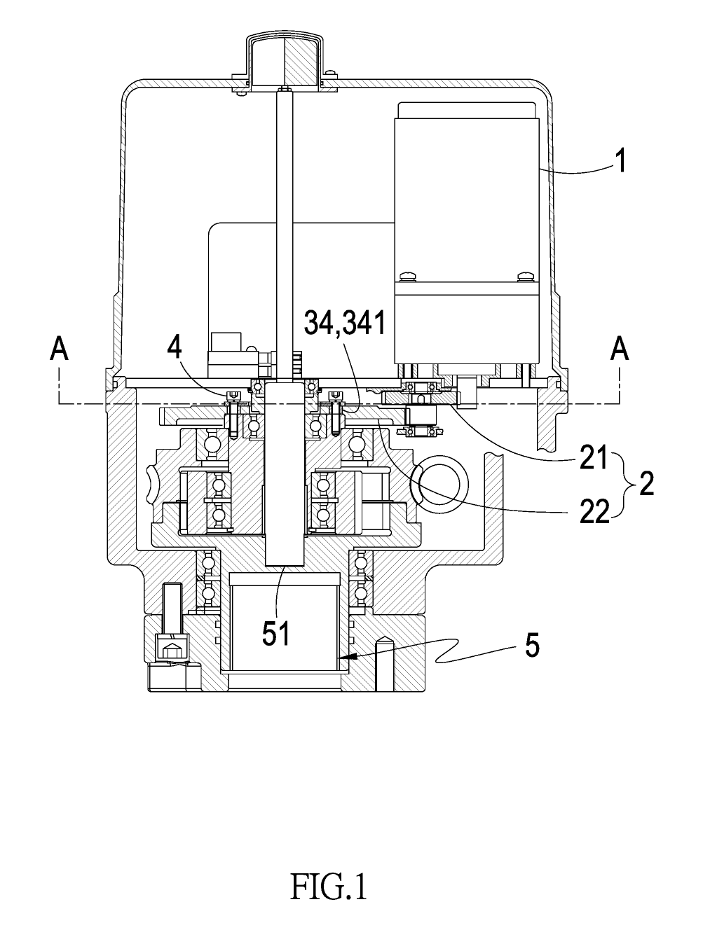

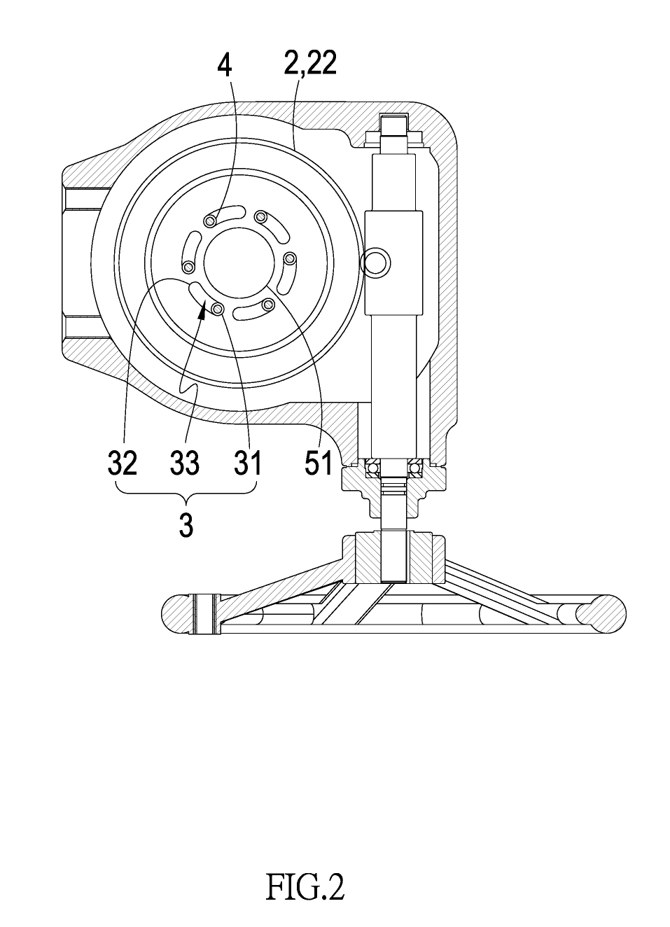

Referring to FIGS. 1 and 2, which are respectively a cross-sectional view of a preferred embodiment of the present invention and a cross-sectional view taken along line A-A of FIG. 1, these drawings show the present invention comprises:

a driving device 1, wherein the driving device 1 can be a reduction motor;

a transmission assembly 2 that is arranged at one side of the driving device 1 and driven by the driving device 1 to operate, the transmission assembly 2 comprising a first gear set 21 connected to the driving device 1 and a second gear set 22 that is connected to a power valve 5, which will be described hereinafter, and is driven by the first gear set 21;

at least one curved, arc slot 3 formed in the transmission assembly 2, the arc slot 3 comprising a constraint end 31, an impact end 32, and a sliding space 33 formed between the constraint end 31 and the impact end 32;

at least one collar section 34 arranged in the arc slot 3 to receive extension of a hammer element 4, which will be described hereinafter, therethrough for coupling the hammer element 4;

at least one cushioning section 341 formed outside the collar section 34;

at least one hammer element 4 that is arranged in the arc slot 3 in a manner of being eccentric with respect to an axis and of the second gear set 22, wherein when the transmission assembly 2 is put into operation, the arc slot 3 and the hammer element 4 are caused to move relative to each other; and

a power valve 5 that is arranged at one side of the hammer element 4 to receive power supplied from the driving device 1 through the hammer element 4, the power valve 5 comprising a power shaft 51 coupled to the transmission assembly 2.

The structure of the technique of this invention can be understood with reference to the above illustration and with arrangement made corresponding to and in combination with such a structure, it is possible, in a limited space, to use a hammering operation to activate the power valve 5 smoothly so as to achieve an advantage of eliminating the issue of inoperability resulting from excessive resistance. A detailed description will be provided below.

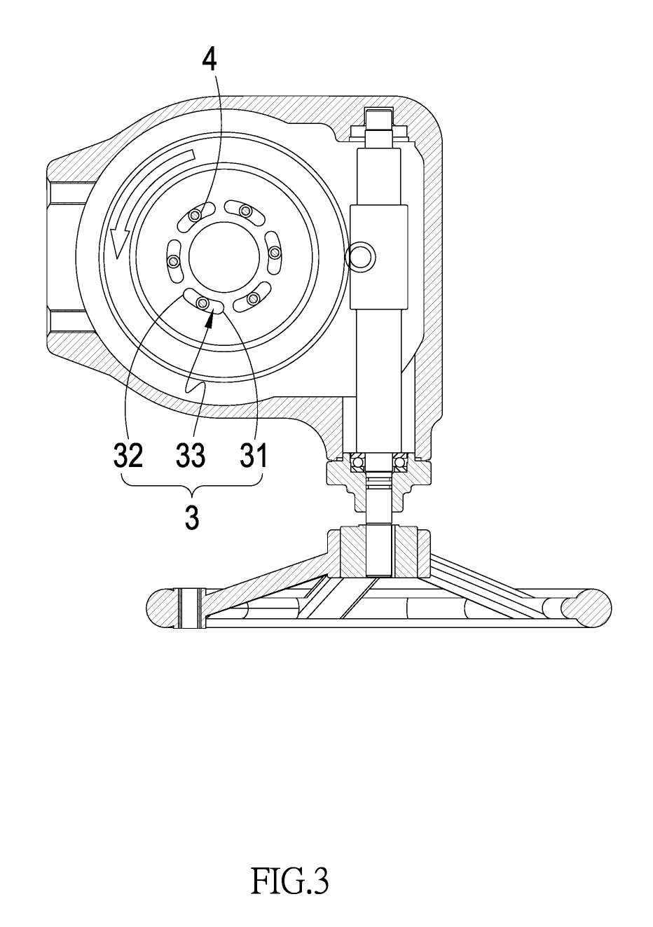

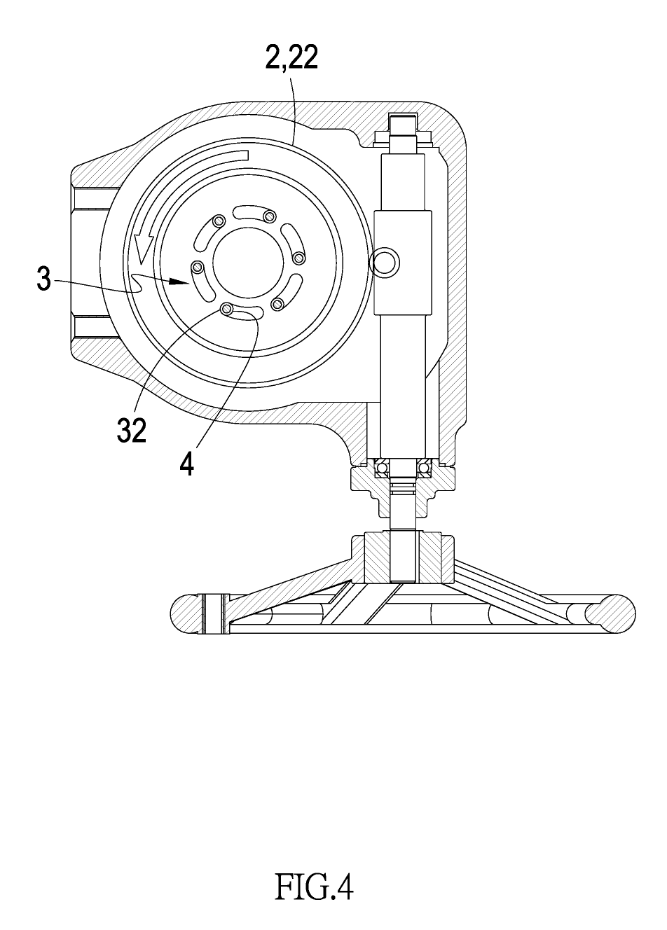

Referring collectively to FIGS. 1-4, which are respectively a cross-sectional view showing a preferred embodiment of the present invention; a cross-sectional view taken along line A-A of FIG. 1; a schematic view of the preferred embodiment of the present invention; and another schematic view of the preferred embodiment of the present invention, with the above-described components assembled together, it can be clearly seen from the drawings that the driving device 1 of the present invention is embodied as a reduction motor and the transmission assembly 2 is made up of the first gear set 21 and the second gear set 22 with the arc slot 3 formed in the second gear set 22, wherein arc slots 3 that are plural in number and are uniformly and circumferentially distributed along an outer circumference of the power shaft 51 are taken as an example of illustration, and the hammer element 4 can be a hexagonal socket screw having a high strength (such as grade 10.9) that is taken as an example in this invention and being set to penetrate through and received in the collar section 34 to improve balance and stability of the hammer element 4 received in the arc slot 3.

In a practical operation, a user activates the driving device 1 to drive the first gear set 21 of the transmission assembly 2, which in turn drives the second gear set 22 in which the arc slots 3 are formed to rotate. As such, the structural arrangement and utilization of space are simple and no expansion of the size of the electrical actuator is required. Further, the transmission assembly 2 is not directly coupled to the power valve 5 and instead drives the operation by means of the hammer element 4, and also, the hammer element 4 is only put into operation when pushed by the arc slot 3, so that the transmission assembly 2, when rotating, may simultaneously drive the hammer element 4 to slide in the sliding space 33, making the hammer element 4 slide from the constraint end 31 of the arc slot 3 to the impact end 32 to cause impact therebetween. Therefore, the driving device 1 may be operated with full speed rotation in a low resistance condition to accumulate a certain amount of kinetic energy before the arc slot 3 impacts the hammer element 4 so as to increase the energy for opening/closing the power valve 5 to help the driving device 1 to drive the power valve 5 that may involve an increased resistance and to prevent the generation of a large amount of heat and wear, which might lead to shortening of service life, due to the driving device 1 being forced to operate. A cushioning effect may be provided for cushioning the impact occurring on the hammer element 4 with the arrangement of the cushioning section 341 on the collar section 34 in order to improve overall durability.

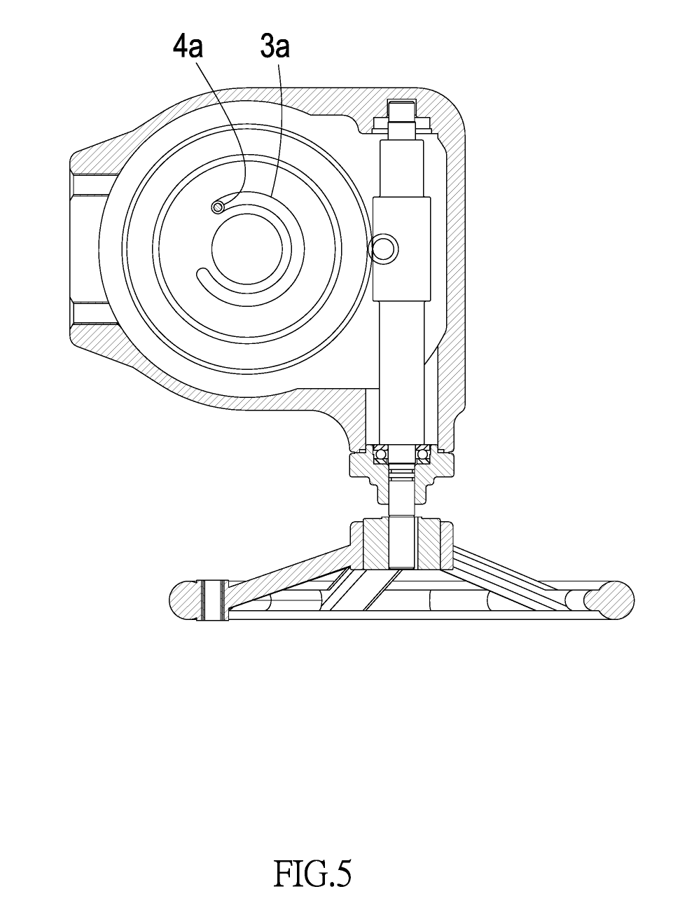

Referring to FIG. 5, which is a schematic view of another embodiment of the present invention, it can be clearly seen from the drawing, the instant embodiment is similar to the previous embodiment and the only difference resides in that the number of the arc slot 3a and that of the hammer element 4a are singular. In this embodiment, the arc slot 3a has a C-shaped configuration to greatly increase the length of non-loaded rotation of the driving device and also to increase the range of rotational motion to heighten the upper limit of accumulation of kinetic energy for the driving device.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An electrical actuator with hammering mechanism, comprising:
a driving device;
a transmission assembly that is arranged at one side of the driving device and driven by the driving device;
at least one arc slot that is formed in the transmission assembly;
at least one hammer element that is arranged in the arc slot such that operation of the transmission assembly causes the arc slot and the hammer element to move relative to each other; and
a power valve that is arranged at one side of the hammer element and receives, through the hammer element, power supplied from the driving device for operation.

2. The electrical actuator with hammering mechanism according to claim 1, wherein the arc slot comprises a constraint end, an impact end, and a sliding space formed between the constraint end and the impact end.

3. The electrical actuator with hammering mechanism according to claim 1, wherein the arc slot comprises a collar section arranged therein to receive and retain the hammer element therein in order to hold the hammer element in position.

4. The electrical actuator with hammering mechanism according to claim 3, wherein the collar section is provided, on an outside thereof, with at least one cushioning section.

5. The electrical actuator with hammering mechanism according to claim 1, wherein the transmission assembly comprises a first gear set connected to the driving device and a second gear set connected to the power valve and driven by the first gear set.

6. The electrical actuator with hammering mechanism according to claim 5, wherein the hammer element is arranged in an eccentric manner with respect to an axis of the second gear set.

7. The electrical actuator with hammering mechanism according to claim 1, wherein the power valve comprises a power shaft coupled to the transmission assembly.

8. The electrical actuator with hammering mechanism according to claim 7, wherein the at least one arc slot and the at least one hammer element comprise multiple arc slots and multiple hammer elements that are uniformly and circumferentially distributed along an outer circumference of the power shaft.

9. The electrical actuator with hammering mechanism according to claim 1, wherein the driving device comprises a reduction motor and the hammer element comprises a hexagonal socket screw.
